(19) United States
(12) Patent Application Publication
(10) Pub. No.: US 2018/0359831 A1
(43) Pub. Date: Dec. 13, 2018

(54) LED LIGHT, AND METHOD FOR INFLUENCING THE SPECTRAL DISTRIBUTION OF THE LED LIGHT

(71) Applicant: EATON PROTECTION SYSTEMS IP GMBH & CO. KG, Schönefeld (DE)

(72) Inventors: Lisa Morr, Hirschhorn (DE); Christian Gerbig, Eberbach (DE)

(21) Appl. No.: 15/776,011

(22) PCT Filed: Nov. 14, 2016
(86) PCT No.: PCT/EP2016/077552

§ 371 Date: May 14, 2018

(30) Foreign Application Priority Data
Nov. 13, 2015 (DE) 10 2015 014 766.8

(51) Int. Cl. H05B 33/08; F21K 9/62

(52) U.S. Cl. CPC H05B 33/0857; F21Y 2115/10; F21K 9/62

(57) ABSTRACT

The invention relates to an LED light (1) comprising a plurality of multichromatic LEDs (2, 3, 4, 5) that form at least LED groups (17) featuring the colors blue, green, and red for additive color mixing; at least one additional LED (5) that is associated with the LED group has a color from the LED group that differs from the colors of the LED group (17).

### PRIORITY CLAIM

The present application is a national phase application of and claims priority to International Application No. PCT/EP2016/077552 with an international filing date of Nov. 14, 2016, which claims priority to German Patent Application No. 10 2015 014 766.8, filed Nov. 13, 2015. The foregoing application are hereby incorporated herein by reference.

### TECHNICAL FIELD

The invention relates to an LED light comprising a plurality of different-colored LEDs (light-emitting diodes). These have at least one LED group comprising the colors blue, green, and red for additive color mixing.

### BACKGROUND

Such a light-emitting diode is known to be a semiconductor diode, in which the property of the generated light may be varied by appropriate doping of the semiconductor material. Above all the spectral range and the efficiency may thus be influenced. There are LEDs having the colors red, green, yellow, orange, and also blue. However, light-emitting diodes are not thermal emitters, like incandescent lamps, for example, and emit light in a limited spectral range. This means that the light emitted by an LED is nearly monochromatic.

### SUMMARY

The possibility also exists of generating white light by means of LEDs. This is possible, for example, using a blue light-emitting diode and a corresponding luminescent pigment. This means that similarly as also in fluorescent tubes, the blue light is partially converted into longer-wave light, wherein white light then results overall due to additive color mixing.

It is also possible to combine LEDs of the colors blue, green, and red with one another for additive color mixing, to thus generate white light.

Several further things are to be considered in conjunction with different-colored light sources and additive color mixing.

To establish, for example, a relationship between human color perception and the physical causes of the color stimulation, there is a so-called CIE standard color system. In this context, the so-called RGB color space or also a so-called CIE standard color table is used to correspondingly represent the entirety of perceptible colors. In this color space, any arbitrary color of the color space may be composed using the primary colors red, green, and blue by a coordinate representation to describe a corresponding component of each primary color, see additive color mixing.

In such a color space, all colors which may be represented by an LED group using the colors blue, green, and red may also be identified by representing a corresponding curve. In this case, there are ranges of the entire theoretical color space which are not achievable by such an LED group, for example. This means that certain perceptible colors are not displayable by the LED group.

A further variable in conjunction with color reproduction is the so-called color reproduction index Ra. This is understood as a photometric variable, using which the quality of the color reproduction of light sources of equal correlated color temperature may be described. The light which is emitted by a black body of corresponding color temperature is used as a reference for judging the reproduction quality in this case, up to a color temperature of 5,000 K. The color reproduction index reaches a value of 100 if a corresponding light source perfectly simulates the spectrum of a reference light source of equal color temperature in the range of the visible wavelengths.

Influencing a spectral distribution of the light in conjunction with LED lights is additionally known from EP 2 601 436. This influence is used for the purpose, for example, of attenuating or also amplifying certain colors in the light emission of the light as needed, wherein this influence takes place with respect to one specific animal species or specific animal species, which have an increased sensitivity in comparison to humans in a corresponding spectral range. Turtles are one example of such an animal species. They are repelled by certain spectral distributions and the brightness perception linked thereto, and therefore, for example, they do not seek out beach regions or the like for laying eggs, in which an illumination having corresponding spectral component is present. This means that this specific component of the spectral distribution is reduced without the illumination important to humans or the like suffering as a result thereof. This is described in EP 2 601 436.

The invention is based on the object of improving an LED light of the type mentioned at the outset such that further ranges of the color space are achievable with high color reproduction index and possibly at the same time influencing of the spectral distribution can take place with respect to elevated sensitivities of specific animal species in comparison to humans.

This object is achieved by the features of claim 1. In particular, the solution is distinguished in that at least one additional LED having a color deviating from the colors of the LED group is associated with the LED group.

Due to this additional LED, by way of the corresponding activation thereof, a further color results, which, together with the colors of the LED group, makes other or also additional ranges of the color space accessible.

A change of the color of the corresponding light has previously been performed, for example, by using filters or the like. These are additional devices, for example, in the region of a transparent cover of the light, through which the light exits. However, such a filter has the disadvantage that the effectivity of the light is reduced, since the light emission is reduced by the filter.

Due to the additional LED, not only are other ranges of the color space reached in a simple manner, but rather also the spectral distribution, in particular of the visible light of the corresponding LED light, is able to be influenced, for example, to take into consideration a higher sensitivity of one specific animal species or specific animal species in comparison to humans.

At the same time, in contrast to filters, the color reproduction index is increased in the LED light, according to the invention, by the additional LED.

Various possibilities are conceivable for implementing a corresponding LED group.

For example, the LED group can be formed from separate individual LEDs. This means that there is one LED having the color blue, one LED having the color green, and one LED having the color red, which are each activatable separately. Of course, the possibility also exists in this context of grouping various LEDs of a specific color and then combining them with the respective other LEDs of the other colors for additive color mixing. A further possibility for implementing an LED group can be seen, for example, in that they have at least one multichip LED. Such a multichip LED is distinguished in particular in that three different LED chips are combined to form a so-called multichip LED.

Still a further possibility for implementing an LED group is, for example, that it is formed from at least one LED module. Such an LED module can have one or more of the above-mentioned LEDs, respectively of the corresponding colors blue, green, and red.

At least one additional LED is associated with each of these LED groups. Of course, depending on the number of the LEDs in a group, multiple additional LEDs can be associated with such a group.

To possibly be able to influence the color of the LED light in a simple manner, the LED group can be formed from individually activatable LEDs. This also applies in conjunction with the additional LED, which can also be individually activatable or can also be part of the LED group and the corresponding implementation of such an LED group.

As already stated, two, three, or more additional LEDs can also be associated with each LED group.

In this context, the additional LED can be designed in a similar manner as the LEDs of the LED group, namely as an individual LED, as part of the multichip LED, or as part of the LED module. This also applies similarly to the two, three, or more additional LEDs.

To be able to activate each LED group or also each individual LED, the LED light can have a control unit for individual activation of each LED group or each LED.

It generally furthermore proves to be advantageous in this case if this activation is used not only, for example, for the power control of the corresponding LEDs, but rather also as a light controller and/or time controller.

This means that, for example, one LED or multiple LEDs is or are activated differently depending on the time of day and also a corresponding light control of the LED light can also take place as a whole, in particular depending on the daylight. In general, for example, the LED light can be turned off by such a light controller in bright daylight, while it is already turned on in the evening or also in bad weather at a specific luminosity, which then reaches its greatest value in darkness.

It was already indicated at the beginning that the LED light can be influenced in its spectral distribution, for example, to take into consideration corresponding elevated sensitivities of certain animal species or one certain animal species in comparison to humans. This takes place according to the invention in the LED light described at the outset in that a light emission of at least one LED of the LED group is reduced or this at least one LED is turned off, while at least one additional LED is turned on and activated for light emission. Such a reduction of the light emission or activation of the additional LED takes place in particular by way of a control of the power supply.

In general, the activation takes place, for example, in that one LED of the LED group having the color blue is reduced or turned off in its color emission, while an additional LED having the color yellow or amber is turned on and activated accordingly.

The color “amber” corresponds in this case to a primary color which is between yellow and orange.

The method according to the invention is used in particular for the purpose of influencing the spectral distribution of the LED light in a range in which one specific animal species or specific animal species have a sensitivity elevated in comparison to humans. The influencing of the spectral distribution takes place in particular in the visible range of the light, see, for example, the turning off of an LED of the color blue and the turning on of an additional LED having the color yellow or amber.

As also already stated in conjunction with the LED light, an activation of all or also only individual LEDs can be carried out in addition to the light control and/or time control.

### BRIEF DESCRIPTION OF THE FIGURES

Advantageous exemplary embodiments of the invention are explained in greater detail hereafter on the basis of the appended figures of the drawings. In the figures:

FIG. 1 shows a cross section through an exemplary embodiment of an LED light according to the invention;

FIG. 2 shows a perspective view diagonally from below of the LED light according to FIG. 1;

FIG. 3 shows a CIE standard color system for essentially one LED group made of LEDs of the colors blue, green, and red;

FIG. 4 shows a CIE standard color system similar to FIG. 3 having activated additional LED;

FIG. 5 shows a spectral distribution of the LED light according to the invention having activated additional LED;

FIG. 6 shows a spectral distribution similar to FIG. 5 without additional LED; and

FIG. 7 shows a schematic sketch of an LED light according to the invention having LED groups and control unit.

### DETAILED DESCRIPTION OF EXAMPLE EMBODIMENTS

FIG. 1 shows a cross section through an exemplary embodiment of an LED light 1 according to the invention. It has a light housing 7 which is approximately semicircular in cross section. This housing has an opening at its lower end in FIG. 1, in which a transparent cover 8 is held by means of a cover retention ring 9. The cover retention ring 9 can be screwed into the light housing 7. The light housing 7 has a reflection unit 11 on its inner side and its outer side is formed as a cooling unit 19 at the same time.

A printed circuit 12, on which a plurality of LEDs 2, 3, 4, and 5 is arranged, is arranged between light housing 7 and cover retention ring 9. These LEDs are arranged in a ring shape inside the light housing.

A cover fixing ring 20 is arranged for fixing the transparent cover and the cover 8 is enclosed by a seal ring 10.

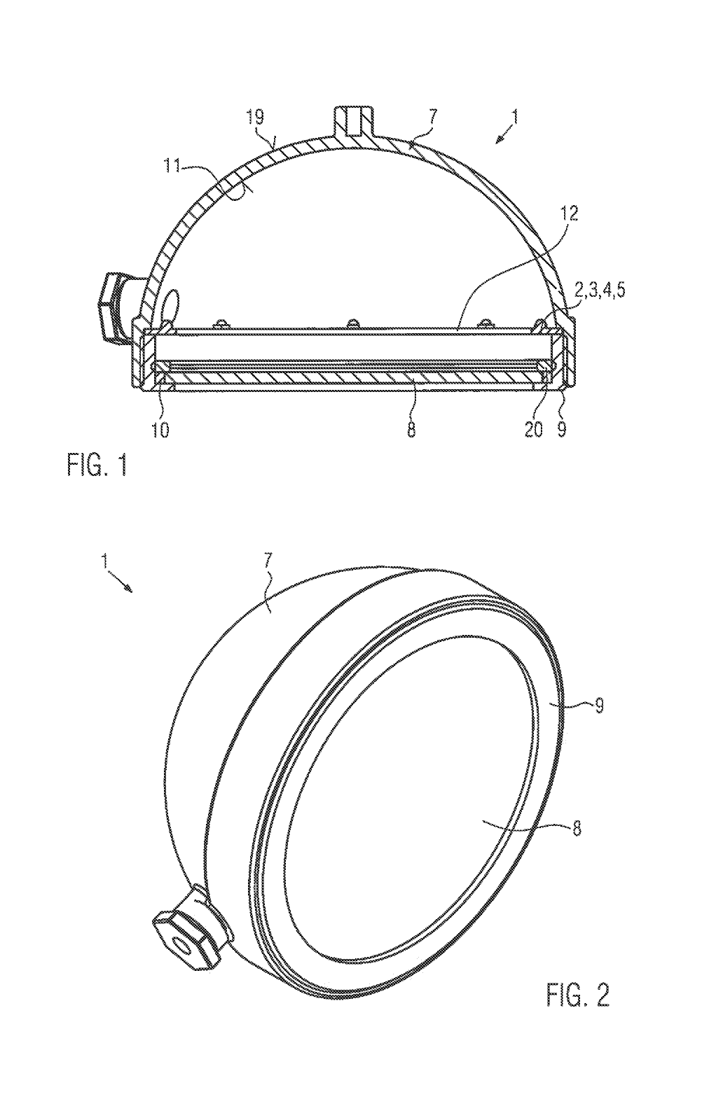

In FIG. 2, the LED light 1 according to FIG. 1 is shown in a perspective view diagonally from below.

Light exits from the LED light 1 through the transparent cover 8 when the corresponding LEDs are turned on.

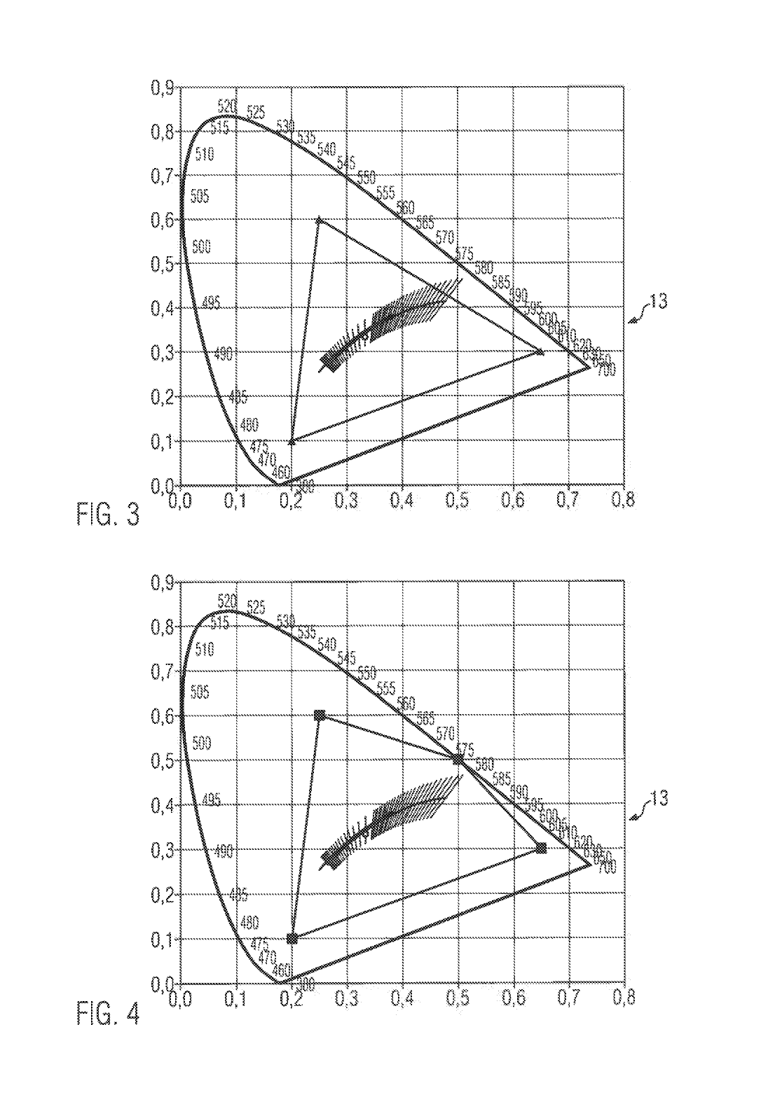

Two different RGB color spaces 13 or CIE standard color systems are shown in FIGS. 3 and 4.

In the RGB color space 13 according to FIG. 3, and also in FIG. 4, a black body curve 14 is indicated, and also in FIG. 3, a corresponding color space is indicated having colors which are displayable by an LED group having the colors blue, green, and red, see the triangular border. These are colors displayable by the LED light without additional LED.

It is recognizable from the RGB color space 13 according to FIG. 3 that certain colors are not displayable, see, for example, a large part of the yellow range between wavelengths of 560 to approximately 580 nm.

If the corresponding additional LED 5, see also the following figures, is additionally turned on, the RGB color space 13 expands according to FIG. 4, see the expansion of the corresponding triangle according to FIG. 3 into approximately a kite shape according to FIG. 4 with additional point at the wavelength of 575 nm. This means that a large range of the yellow color space additionally becomes accessible.

The illustration of the RGB color space 13 according to FIG. 4 corresponds to an additional LED of the color yellow or amber.

Of course, it is possible to also expand the color space in other directions in relation to that according to FIG. 3, for example, by switching on different-colored additional LEDs.

In summary, it results according to FIGS. 3 and 4 that the color space of RGB LEDs, see FIG. 3, can be expanded by associating an additional LED, see FIG. 4.

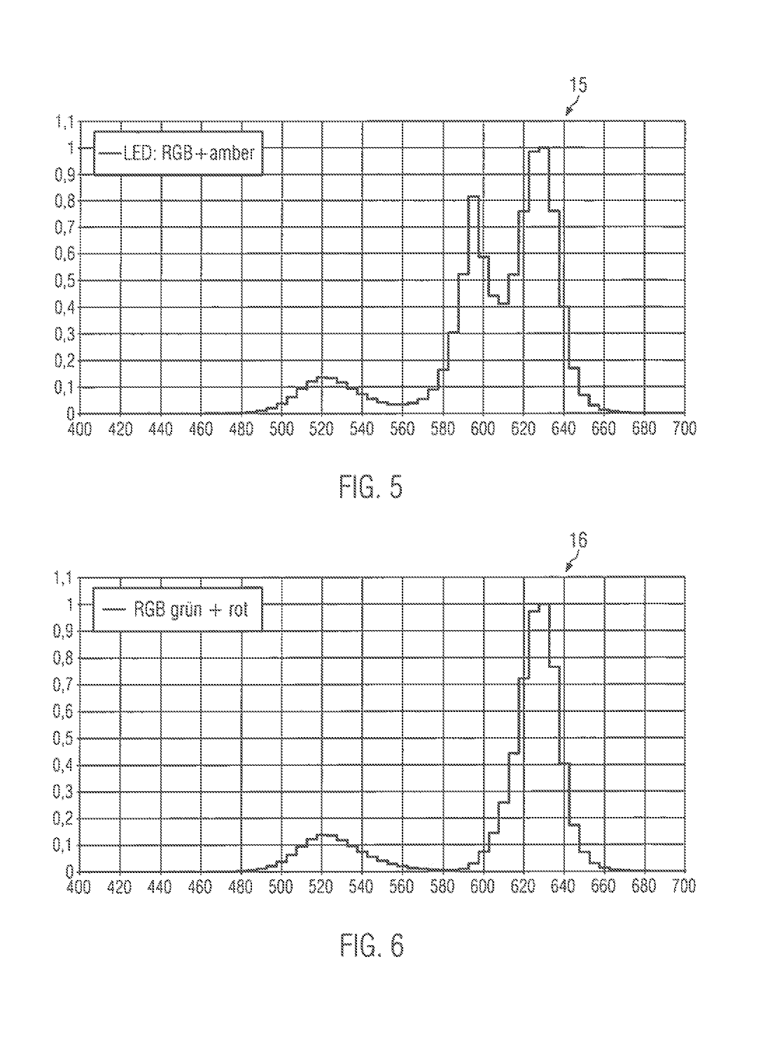

The illustration in FIGS. 5 and 6 is similar, which shows a corresponding spectral distribution in particular in the range of the visible light of the LED light according to the invention having two different circuits of corresponding LEDs.

In FIG. 5, the spectral distribution 15 having an LED group of the colors blue, green, red and an additional LED of the color amber is shown. However, it is additionally to be noted in this case that a corresponding LED of the LED group having the color blue is turned off. A corresponding color reproduction index has a value of 64 and a spectral distribution results which is adapted to a sensitivity of a specific animal species, turtles here. This means that the spectral distribution is turtle-friendly, i.e., there is no deterrence or the like of turtles who wish, for example, to lay eggs on a beach or the like in the case of corresponding illumination using spectral distribution according to FIG. 5. Furthermore, the illumination is sufficient for humans to walk along paths or work in factories arranged in the vicinity of the region of the egg laying of the turtles.

In the corresponding spectral distribution 16 according to FIG. 6, only the LEDs having the colors red and green are turned on of the LED group, wherein the LED group having the color blue is still turned off, see also spectral distribution 15 according to FIG. 5.

The correspondingly computed color reproduction index is less in FIG. 6, namely 43.

It can be seen in conjunction with FIGS. 5 and 6 that according to the invention, by way of use of the additional LED or LEDs and corresponding activation of the LED groups of the LED light, the spectral distribution is adaptable with respect to corresponding different sensitivities of one specific animal species and humans, for example, to not prevent the animal species from laying eggs, for example, due to a deterrent illumination. Of course, the indicated animal species was only by way of example, and other animal species can possibly also be taken into consideration by other spectral distributions according to FIGS. 5 and 6 in accordance with their light sensitivity.

Since the use of a filter for adapting the spectral distribution is not necessary according to the invention, the light emission is also not negatively influenced in any way and a higher color reproduction index is achieved simultaneously.

Overall, a good visual effectiveness of the LED light according to the invention results.

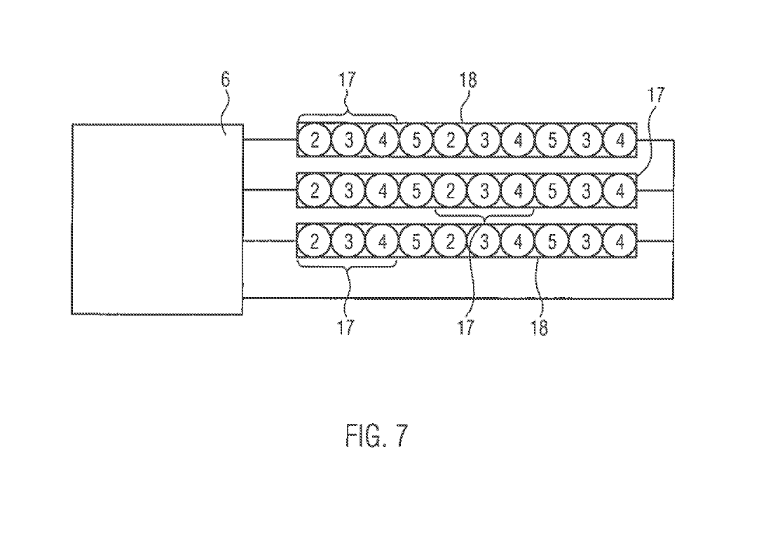

A corresponding LED group or RGB LED may be implemented in different ways. One example is shown in FIG. 7. Other examples can comprise an LED group made of separate individual LEDs, wherein these individual LEDs respectively have the color blue, green, or red. Furthermore, each LED group can be formed from at least one multichip LED or from at least one LED module. Such an LED module can in turn comprise individual LEDs or also multichip LEDs.

Of course, it is also possible in this case that one, two, three, or more additional LEDs are associated with one corresponding LED group. Moreover, the additional LED or also the plurality of these LEDs can also be formed as an individual LED, as part of a multichip LED, or as part of the LED module, and therefore the additional LED can be handled and installed together with the LED group.

FIG. 7 shows various LED groups 17 each having one LED 2, 3, 4 of the color blue, green, and red, respectively. At least two of the LED groups 17 are part of a higher-order LED module 18. In addition, an additional LED 5, for example, of the color yellow or amber, is part of each LED module 18.

The illustration according to FIG. 7 is only by way of example and the possibility also exists that each LED module 18 comprises only one LED group 17 and the additional LED 5 is associated with the module. In addition, the possibility exists that each of the individual LEDs 2, 3, 4, or 5 according to FIG. 7 is already an LED group 17, which comprises, for example, one LED of the color blue, green, red and the color of the corresponding additional LED.

It is also possible that each of the individual LEDs 2, 3, and 4 according to FIG. 7 comprises a multichip LED, which already comprises three LEDs of the colors blue, green, and red.

Further combinations of LEDs, either individually or as a group, and also of LED groups and LED modules, are possible. The illustration of FIG. 7 is used only to explain the invention and in particular to explain the association of an additional LED with, for example, an RGB LED.

A control unit 6 of the LED light 1 is associated with the various LEDs 2, 3, 4, and 5. It is used for activating the individual LEDs and in particular, see the spectral distribution 15 and 16 according to FIGS. 5 and 6, to activate one LED of the corresponding LED group and to activate the additional LED or LEDs. Thus, for example, a blue LED of each LED group is turned off and the corresponding additional LED 5 is turned on. The different spectral distributions 15 and 16 according to FIGS. 5 and 6 are thus implemented. This also applies similarly to FIGS. 3 and 4 and the different ranges of the RGB color space.

The corresponding control unit can be used in this context not only for the activation of the individual LEDs to change the spectral range, but rather can also be used overall for the light controller and/or time controller. The light controller can comprise in this case overall dimming and turning on and off the LED light, wherein the time controller includes a corresponding time circuit, for example, to turn off the LED light in the event of daylight and sufficient illumination.

According to the invention, an LED light and a corresponding method result, in which the light emission of at least one LED of an LED group can be reduced or this at least one LED is turned off. Instead of this LED which is reduced in the light emission or turned off, at least one additional LED is then turned on and activated for light emission. This generally takes place by a control of the power supply of the various LEDs. In particular, LED light and method according to the invention are used for the purpose of influencing a corresponding spectral distribution of the LED light in a range in which a specific animal species or specific animal species have an elevated sensitivity in comparison to humans.

At the same time, as a result of the invention, the light emission is prevented from being reduced by filters, as otherwise, and a higher color reproduction index is enabled.

1. A light emitting diode (LED) light (1) comprising a plurality of different-colored LEDs (2, 3, 4), which form at least one LED group (17) having colors blue, green, and red for additive color mixing, characterized in that at least one additional LED (5) having a color deviating from the colors of the LED group (17) is associated with the LED group.

2. The LED light as claimed in claim 1, characterized in that the LED group (17) is formed from separate individual LEDs (2, 3, 4).

3. The LED light as claimed in claim 1, characterized in that the LED group (17) has at least one multichip LED.

4. The LED light as claimed in claim 1, characterized in that the LED group (17) is formed from at least one LED module (18).

5. The LED light as claimed in claim 1, characterized in that the LED group (17) is formed from individually activatable LEDs (2, 3, 4, 5).

6. The LED light as claimed in claim 1, characterized in that the additional LED (5) has the color yellow or amber.

7. The LED light as claimed in claim 1, characterized in that two, three, or more additional LEDs (5) are associated with each LED group (17).

8. The LED light as claimed in claim 1, characterized in that the additional LED (5) is designed as an individual LED, as part of a multichip LED, or as part of an LED module (18).

9. The LED light as claimed in claim 1, characterized in that the LED light (1) has a control unit (6) for the individual activation of each LED (2, 3, 4, 5).

10. The LED light as claimed in claim 9, characterized in that the control unit (6) is furthermore designed as a light control unit and/or time control unit.

11. A method for influencing a visible light portion of a spectral distribution of an LED light (1) comprising a plurality of different-colored LEDs (2, 3, 4), which form at least one LED group (17) having the colors blue, green, and red for additive color mixing, wherein at least one additional LED (5) having a color deviating from the colors of the LED group (17) is associated with the LED group, characterized by the following steps:
i) reducing, by control of a power supply by a control unit (6), the light emission of or turning off at least one LED (2, 3, 4) of the LED group (17), and
ii) turning on and activating, by control of the power supply by the control unit (6), the at least one additional LED (5) for light emission.

12. The method as claimed in claim 11, characterized by activation, in step i), of an LED of the LED group (17) having the color blue and, in step ii), an the additional LED (5) having the a color yellow or amber.

13. The method as claimed in claim 11, characterized by influencing the spectral distribution (15, 16) of the LED light (1) in a range in which a specific animal species has an elevated light sensitivity in comparison to humans.

14. The method as claimed in claim 11, characterized by activation of all LEDs (2, 3, 4, 5) by the control unit (6) for the light controller and/or time controller.
